(19) United States
(12) Patent Application Publication
(10) Pub. No.: US 2005/0284946 A1
(43) Pub. Date: Dec. 29, 2005

(54) Cogeneration system and energy supply system

(76) Inventors: Akiyoshi Komura, Hitachi (JP); Kazumasa Ide, Hitachiota (JP); Masahiro Watanabe, Hitachi (JP); Hiroshi Kusumoto, Hitachinaka (JP); Yusuke Kihara, Hitachi (JP); Atsushi Shimada, Hitachinaka (JP); Masatoshi Watanabe, Ushiku (JP); Yoshifumi Kubo, Takahagi (JP)

Correspondence Address: DICKSTEIN SHAPIRO MORIN & OSHINSKY LLP, 2101 L Street, NW, Washington, DC, 20037, US

(21) Appl. No.: 11/167,307

(22) Filed: Jun. 28, 2005

(30) Foreign Application Priority Data
Jun. 28, 2004 (JP) 2004-189096

(51) Int. Cl. G05D 23/00

(52) U.S. Cl. 237/2 B

(57) ABSTRACT

The present invention provides a household cogeneration system which is adapted to a consumption power amount and a consumption heat amount of each consumer in an ordinary house and can easily handle a failure. The cogeneration system has an energy generating device constructed by: a plurality of electric/heat energy generating modules each having a jacket for sending electric energy and heat energy; a plurality of heat energy generating modules each having a jacket for sending heat energy and constructed by a mechanical power generating device and a heat pump device; and a base having a jacket for receiving the electric energy and the heat energy from the plurality of energy generating modules and supplying the energy from the modules in a lump to a consumer side.

### CLAIM OF PRIORITY

This application claims priority from Japanese Application Serial No. 2004-189096, filed on Jun. 28, 2004, the content of which is hereby incorporated by reference into this application.

### FIELD OF THE INVENTION

The present invention relates to a cogeneration system and an energy supply system.

### BACKGROUND OF THE INVENTION

A cogeneration system in which a power generating device is installed in an ordinary house and part of power and heat consumed in the house is covered by the device is conventionally known (refer to, for example, “Residential Fuel Cell Systems”, Ken Tabata, Journal of Society of Automotive Engineers of Japan, Vol. 58, No. 3, p. 83).

The cogeneration system is an energy supply system of obtaining power from the power generating device, collecting exhaust heat of the power generating device, and using the exhaust heat as a heat source. The heat generating device is, generally, a fuel cell, a gas engine, and the like.

The consumption power amount and the consumption heat amount vary among individual consumers including ordinary households. The maximum values of them vary among consumers and, moreover, the ratio between the consumption power amount and the consumption heat amount also varies. Consequently, in the case of introducing the cogeneration system into an ordinary house, since the maximum values of a power generation amount and an exhaust heat amount of the system and the ratio between the power generation amount and the exhaust heat amount are determined, it is difficult to introduce a system capable of supplying the power amount and the heat amount adapted for each consumer.

In the case of introducing the cogeneration system to an ordinary household, as the owner does not have expert knowledge, the owner has to ask a serviceperson for a repair when a failure occurs. When a failure occurs in the system, the owner makes a contact with a serviceperson and cannot use the system until the repair work by the serviceperson is finished.

The present invention has been achieved in consideration of the above problems and an object of the invention is to provide a household cogeneration system which is adapted to a consumption power amount and a consumption heat amount of each consumer in an ordinary house and can easily handle a failure.

### SUMMARY OF THE INVENTION

According to an aspect of the present invention, there is provided a cogeneration system for supplying electric energy and heat energy including: an electric/heat energy generating module having an electric energy generating source for generating electric energy and a heat energy generating source for generating heat energy by using the heat generated by the electric energy generating source, wherein the electric/heat generating module has an electric energy transmitter for transmitting heat generated by the electric energy generating source of the electric/heat energy generating module to the outside of the electric/heat generating module, and a heat energy transmitter for transmitting heat generated by the heat energy generating source of the electric/heat energy generating module, and a base is provided, which has an electric energy input part to which the electric energy from the electric energy transmitter of the electric/heat energy generating module is transmitted, and a heat energy input part to which the heat energy is transmitted from the heat energy transmitter of the electric/heat energy generating module.

According to another aspect of the present invention, there is provided an energy supply system including: a plurality of heat energy generating modules each having a heat energy generating source for generating heat energy; and a base having therein the plurality of heat energy generating sources, wherein the heat energy generating source has an energy transmitter for transmitting generated heat to the outside of the module, and the base has therein a heat energy input part to which the heat energy transmitted from the energy transmitter of the heat energy generating module is sent.

The other features of the present invention will be described in the following.

According to the present invention, the electric/heat energy generating module(s) and the heat energy generating module(s) can be freely combined with the base of the cogeneration system. Thus, the cogeneration system adapted to the consumption power amount and the consumption heat amount of each consumer can be provided.

### BRIEF DESCRIPTION OF THE DRAWINGS

FIG. 1 is a configuration diagram showing a first embodiment of a household cogeneration system according to the present invention.

FIG. 2 is a perspective bird's eye view showing a configuration of a cogeneration unit in the first embodiment of the invention.

FIG. 3 is a characteristic diagram showing a driving method of the cogeneration unit in the first embodiment of the invention.

FIG. 4 is an inspection screen of the cogeneration unit in the first embodiment of the invention.

FIG. 5 is a table illustrating display buttons in the inspection screen of the cogeneration unit in the first embodiment of the invention.

FIG. 6 is a configuration diagram showing a second embodiment of a household cogeneration system according to the invention.

### DETAILED DESCRIPTION OF THE PREFERRED EMBODIMENTS OF THE INVENTION

The details of a household cogeneration system according to the present invention will be described hereinbelow on the basis of embodiments shown in the diagrams.

### First Embodiment

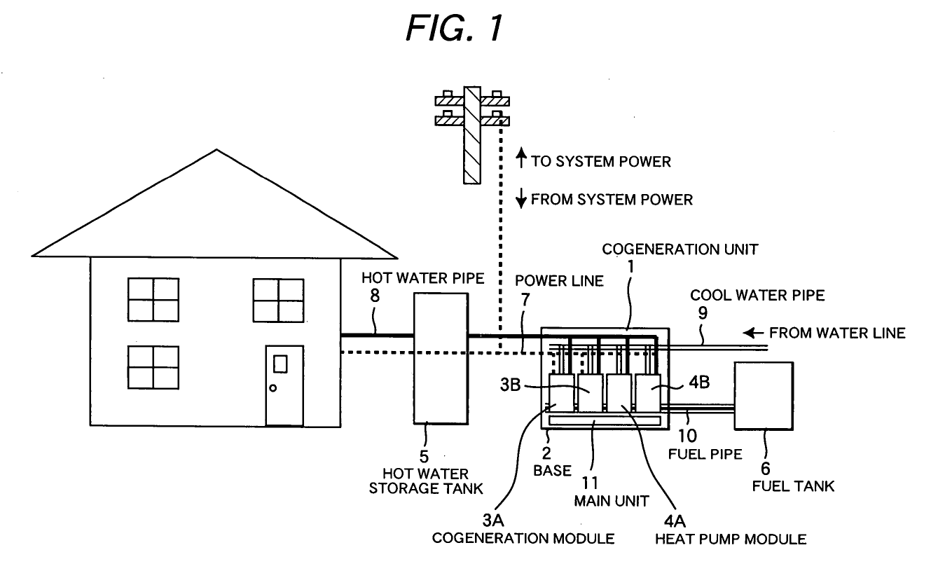

FIG. 1 shows a first embodiment of the invention in which a cogeneration unit 1 including a base 2 playing the role of a case, a plurality of cogeneration modules 3A, 3B, . . . , and a plurality of heat pump modules 4A, 4B, . . . is installed in an ordinary house. The cogeneration module 3 has a heat generating device constructed by, for example, a gas engine and a heat generator, and can collect exhaust heat of the heat generating device and supply hot water via an exhaust heat using device such as a heat exchanger. The heat pump module 4 has, for example, a gas engine and a heat pump and can supply hot water. The system has, other than the cogeneration unit 1, a hot water storage tank 5 for storing hot water generated by the cogeneration unit and a fuel tank 6 for storing fuel used in the cogeneration unit. Although the fuel tank is installed in FIG. 1, fuel may be directly received from an infrastructure of city gas or the like.

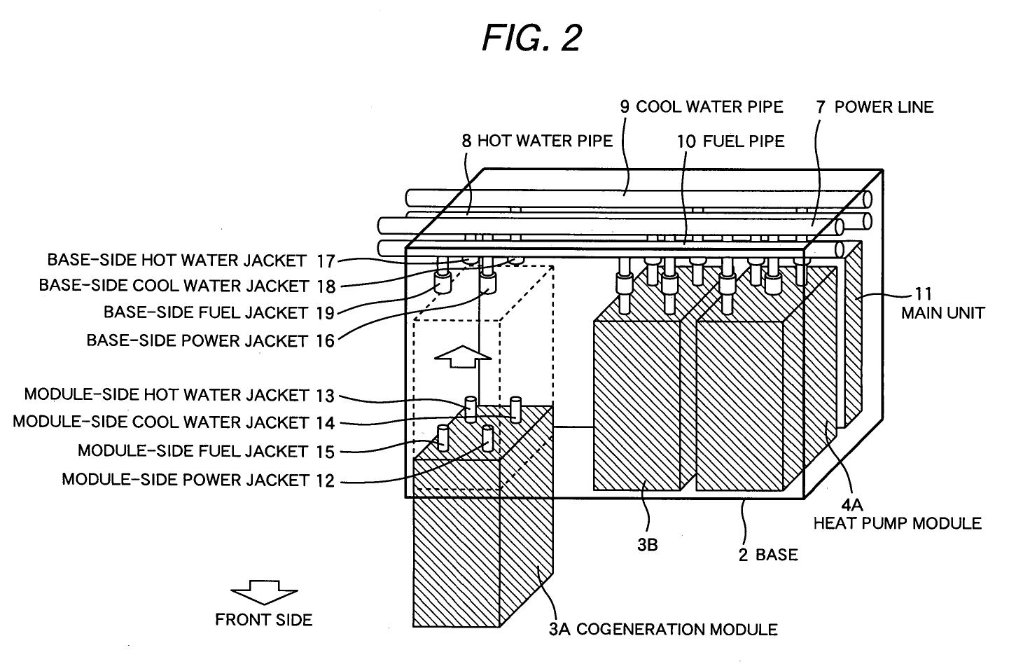

FIG. 2 shows a concrete configuration of the cogeneration unit of the embodiment. The cogeneration unit 1 has the base 2 playing the role of a case, the plurality of cogeneration modules 3A, 3B, . . . , and the plurality of heat pump modules 4A, 4B, . . . . The base 2 has a main unit 11 that controls the system, a power line 7 for sending generated power, a cold water pipe 9 for receiving cold water, a hot water pipe 8 for sending hot water, and a fuel pipe 10 for receiving fuel. Each of the power line 7, cold water pipe 9, hot water pipe 8, and fuel pipe 10 is connected to an external pipe.

The base and each of the modules are connected to each other via a detachable jacketed attaching part. A connection part on the cogeneration module side is constructed by a module-side power jacket 12 for sending generated power, a module-side cold water jacket 14 for receiving cold water, a module-side hot water jacket 13 for sending hot water, and a module-side fuel jacket 15 for receiving fuel. In correspondence with the configuration, a connection part on the base side is similarly constructed by a base-side power jacket 16 for receiving the generated power, a base-side cold water jacket 18 for sending the cold water, a base-side hot water jacket 17 for receiving the hot water, and a base-side fuel jacket 19 for sending the fuel. In the case of the heat pump module, the connection part on the module side is constructed by a module-side cold water jacket for receiving cold water, a module-side hot water jacket for sending hot water, and a module-side fuel jacket for receiving fuel. At the time of connecting the base unit and the heat pump module to each other, the base-side power jacket is not used. Any of the cogeneration module and the heat pump module can be freely detached from the base. Although each of the pipes has some jackets in FIG. 2, those jackets may be combined to one jacket.

With such a configuration, the number of modules can be adjusted in accordance with a consumed power amount and an amount of heat consumed for hot water in each house, so that the supply power amount and the supply heat amount of the cogeneration system can be freely set. It is assumed that the rated power of the cogeneration module is 250 W, the rated heat amount of the cogeneration module is 250 W, and the rated heat amount of the heat pump module is 1,000 W. In the case where the power amount and the heat amount necessary for a house A are 1 kW and 4 kW, respectively, it is sufficient to provide four cogeneration modules and three heat pump modules. On the other hand, in the case where the power amount and the heat amount necessary for a house B are 1 kW and 6 kW, respectively, it is sufficient to provide four cogeneration modules and five heat pump modules. Since a conventional cogeneration system is constructed by a single power generating device, the ratio between the supply power amount and the supply heat amount of the system is fixed and is not adjustable. In the embodiment, however, by adjusting the number of cogeneration modules and the number of heat pump modules, the ratio between the supply power amount and the supply heat amount of the system can be freely set.

The main unit 11 has a control board from which all of instructions for operating the modules are transmitted. The position and kind of a module mounted on the base are determined in accordance with the presence or absence of connection of a jacket and the kind of connection of the jacket. Operation data at different times is stored in a storage chip on the control board. The operation data includes a power use amount, a hot water use amount, water-level in the hot water storage tank, temperature of hot water in the hot water storage tank, a fuel use amount, a remaining amount in the fuel tank, exhaust temperature, power supply amounts and hot water supply amounts of the modules, and operation time of the modules. On the other hand, each of the modules has only a storage chip in which operation data of the module is stored. Since each module does not have a control board, the price of the module can be suppressed and, in addition, the weight and the size of the module can be minimized. When a failure occurs in a module, the operation data of the module, necessary at the time of repairing the module can be read from the storage chip of the module.

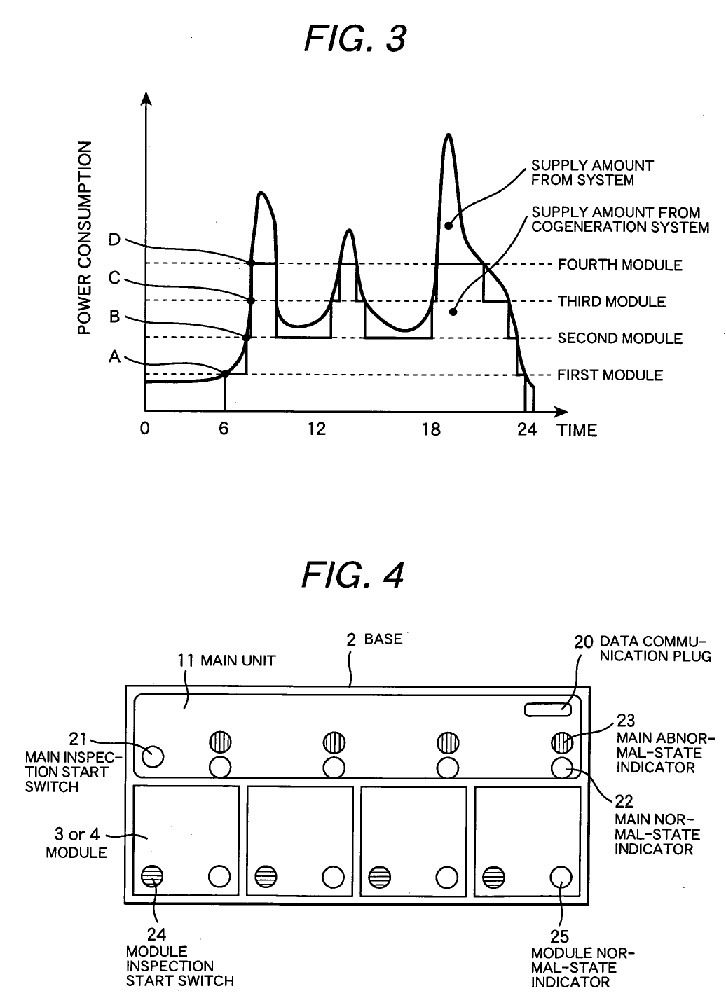

An operating method of the modules will be described. It is assumed, as an example, that power consumption fluctuates with time as shown in FIG. 3. As shown in FIG. 3, the number of modules to be operated is controlled so that the maximum power can be supplied within the consumption power amount on the basis of the power consumption that fluctuates with time. The number of the modules operated is controlled in such a manner that, when the rated power of the modules is 250 W, operation of the first module is started at the point A when the power consumption becomes 250 W, operation of the second module is started at the point B when the power consumption becomes 500 W, and operation of the third module is started at the point C when the power consumption becomes 750 W. The difference between the power consumption amount and the amount of power generated by the cogeneration unit is complemented by a system power. Since the conventional cogeneration system has a single power generating device, the power consumption that fluctuates with time is addressed by partial load operation, and the modules have to be operated with efficiency lower than that in rated operation. In the embodiment, although the power consumption fluctuates with time, the modules are always operated with rated outputs. Therefore, the efficiency does not deteriorate. Operation is similarly performed with respect to the consumption heat amount. The consumption heat amount of a general household has the peak in the evening and night in which people prepare dinner, clear dishes, and take a bath. Consequently, hot water generated by the modules in the daytime is stored in the hot water storage tank to complement the difference between the consumption heat amount and the amount of heat generated by the cogeneration unit.

The modules are selectively operated in order from the module having shortest operation time with reference to operation time of the modules. As a result, the operation time of the modules can be averaged and it can prevent a situation that the period of using a specific module is short.

A module inspecting method will now be described. FIG. 4 shows an inspection screen of the cogeneration unit. At the time of a normal operation, when a module reacts normally to an instruction from the main unit, a main normal-state indicator 22 lights up. When a module does not react normally, a main abnormal-state indicator 23 lights up. At the time of a normal inspection, by depressing a main-unit inspection start switch 21, each of the modules is inspected. When a normal state is recognized by the inspection, the main normal-state indicator 22 lights up. When an abnormal state is recognized, the main abnormal-state indicator 23 lights up. When the main abnormal-state indicator 23 lights up, by depressing a module inspection start switch 24 of a module, the module can be independently inspected. When a normal state is recognized by the inspection, a module normal-state indicator 25 lights up. Since the inspection can be conducted on each of the modules, also in a state where a module is not assembled in the cogeneration unit after manufacture of the module, before replacement of the module, or the like, the module can be singly inspected.

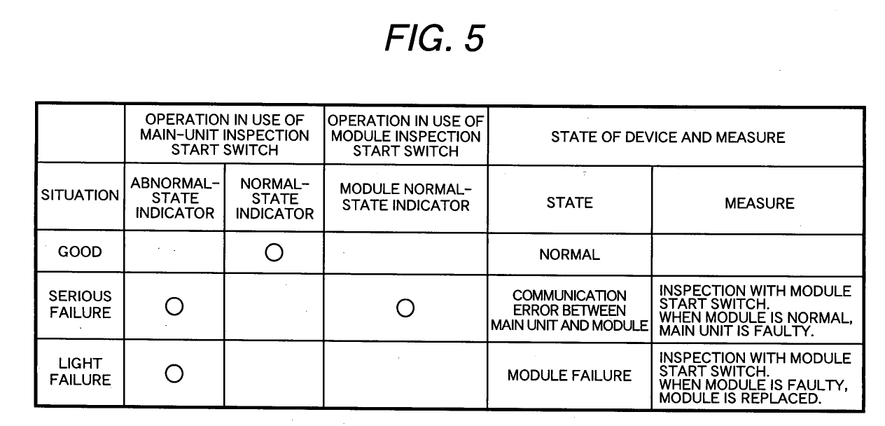

FIG. 5 illustrates states of a device of which indicator in the inspection screen lights up and measures. In the case where the main normal-state indicator lights on at the time of using the main-unit inspection start switch, the state of the module is normal. In the case where the main abnormal-state indicator lights on at the time of using the main-unit inspection start switch and the module normal-state indicator lights on at the time of using the module inspection start switch, the main unit is faulty and the main unit has to be replaced. On the other hand, in the case where the main abnormal-state indicator lights on at the time of using the main-unit inspection start switch and the module normal-state indicator does not light on at the time of using the module inspection start switch, the module is faulty and has to be replaced.

When a failure occurs, since the conventional cogeneration system is constructed by a single power generating device, the whole system has to be stopped on occurrence of the failure. In contrast, in the embodiment, even in the case where one of the modules fails, the modules other than the failed module can continue operating, so that it is unnecessary to stop the whole system. Since it is sufficient to replace only the failed module with a new module, even an owner having no expert knowledge can easily make a repair at the time of failure. In the embodiment, the system is constructed by the plurality of modules, so that the weight of each module is small. For example, when the rated electric output of the cogeneration module is 250 W, the weight of the module is about 10 kg or less so that one adult person can replace the module.

The procedure of dealing with a failure is performed by; (1) detection of a failure in a module, (2) stop of the failed module (while operating the other modules), (3) sending of notification to a service center, (4) sending of a new module by mail or delivery service from the service center, (5) replacement of the failed module with the new module by the consumer, and (6) sending of the failed module to the service center by mail or delivery service. In this case, it is unnecessary to ask for a service person. Even a consumer having no expert knowledge can easily deal with the failure. A failure can be also handled by a procedure of (1) detection of a failure in a module, (2) stop of the failed module (while operating the other modules), (3) sending of notification to a service center, (4) sending of a service person from a nearby service company, and (5) replacement of the module. In this case, one service person is enough and, moreover, even a person having no expert knowledge can deal with a failure.

In the embodiment, the power generating device of the cogeneration module is constructed by the gas engine and the power generator. Similar effects can be also expected by using a power generating device constructed by a fuel cell.

Although a plurality of cogeneration modules and a plurality of heat pump modules are installed in a base unit in the embodiment, only a plurality of cogeneration modules or only a plurality of heat pump modules may be installed in the base-unit.

### Second Embodiment

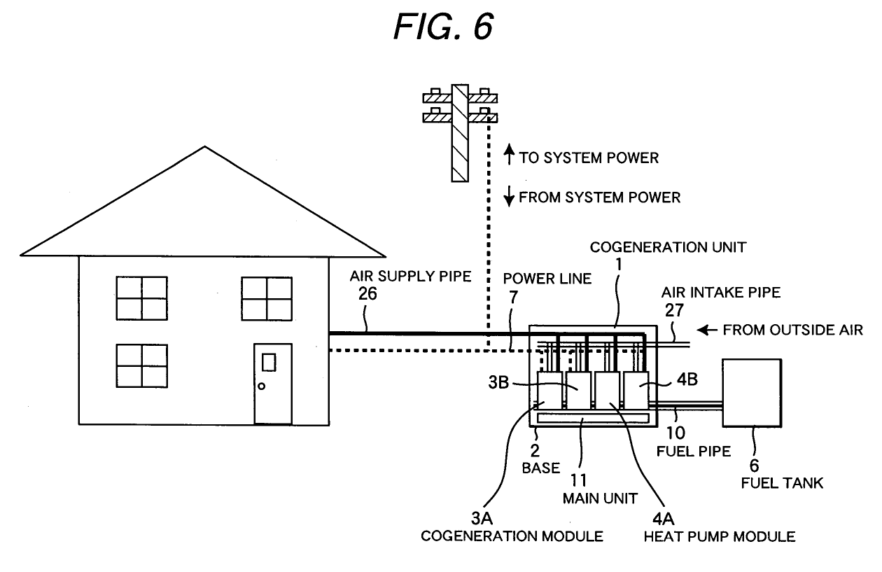

FIG. 6 shows a second embodiment of the present invention, and the cogeneration unit 1 constructed by the base 2 playing the role of the case, the plurality of cogeneration modules 3A, 3B, . . . and the plurality of heat pump modules 4A, 4B, . . . is provided in an ordinary house. In the second embodiment, the cogeneration module 3 has the power generating device constructed by, for example, a gas engine and a power generator. The cogeneration module 3 can supply power generated by the power generating device, collect exhaust heat of the power generating device, and supply cooling air or heating air via an exhaust heat using device such as an adsorption refrigerator or a heat exchanger. The heat pump module 4 has, for example, a gas engine and a heat pump and can supply cooling or heating air. The system has, other than the cogeneration unit 1, a fuel tank 6 for storing fuel used in the cogeneration unit. The second embodiment is different from the first embodiment with respect to the point that exhaust heat of the cogeneration module and heat generated by the heat pump module is used for cooling and heating. In the embodiment, the supply power amount and the supply heat amount of the cogeneration system can be freely set according to the consumption power amount and the consumption heat amount for cooling and heating in each house.

The exhaust heat is used for hot water in the first embodiment and used for cooling and heating in the second embodiment. Also when both of the uses may be combined, similar effects can be expected.

In the embodiment of the invention, an electric/heat energy generating module and a heat energy generating module can be freely combined to the base of the cogeneration system. Thus, the cogeneration system adapted to the consumption power amount and the consumption heat amount of each consumer can be provided.

Even if a failure occurs in one of modules mounted on the base, the other modules can continue operating, so that the system does not have to be stopped at the time of a failure. Moreover, it is sufficient to replace a failed module with a new module. Consequently, even if the owner does not have expert knowledge, he/she can easily make a repair when a failure occurs.

1. A cogeneration system for supplying electric energy and heat energy, comprising:
an electric/heat energy generating module having, in a base, an electric energy generating source for generating electric energy and a heat energy generating source for generating heat energy by using the heat generated by the electric energy generating source,
wherein said electric/heat generating module has an electric energy transmitter for transmitting heat generated by the electric energy generating source of said electric/heat energy generating module to the outside of the electric/heat generating module, and a heat energy transmitter for transmitting heat generated by the heat energy generating source of said electric/heat energy generating module, and
said base has an electric energy input part to which the electric energy from the electric energy transmitter of said electric/heat energy generating module is transmitted, and a heat energy input part to which the heat energy is transmitted from the heat energy transmitter of said electric/heat energy generating module.

2. The cogeneration system according to claim 1, wherein the heat energy generating source of said electric/heat energy generating module has a heat pump and a water taking part for taking water from the outside, and
the heat energy generated by the heat energy generating source of said electric/heat energy generating module is cold water or hot water.

3. The cogeneration system according to claim 1, wherein the heat energy generating source of said electric/heat energy generating module has a heat pump and an outside air taking part of taking outside air, and
the heat energy generated by the heat energy generating source of said electric/heat energy generating module is cooling air or heating air.

4. The cogeneration system according to claim 1, wherein said electric/heat energy generating module has a fuel input part for supplying fuel used by said electric energy generating source of said electric/heat energy generating module, and
said base has a fuel supply part for supplying fuel to the fuel input part of said electric/heat energy generating module.

5. The cogeneration system according to claim 1, further comprising a heat energy generating module having a heat energy generating source of generating heat energy,
wherein said heat energy generating module has a heat energy transmitter for transmitting heat energy generated by said heat energy generating source to the outside of the module, and
said base has a heat energy input part to which heat energy is transmitted from the heat energy transmitter of said heat energy generating source.

6. The cogeneration system according to claim 1, wherein said base has a module operation controller for controlling operation of said electric/heat energy generating module or said heat energy generating module.

7. The cogeneration system according to claim 6, further comprising a load information obtaining function of obtaining load information of equipment to which energy is to be supplied,
wherein the number of said electric/heat energy generating modules or said heat energy generating modules is adjusted on the basis of the load information obtained by said load information obtaining function.

8. The cogeneration system according to claim 6, further comprising a module operation information storage for storing information regarding operation time of said electric/heat energy generating module or said heat energy generating module,
wherein said module operation controller gives a high priority on a module whose operation time is shortest and operates the module on the basis of the information regarding the operation time of the modules stored in said operation information storage.

9. The cogeneration system according to claim 1, wherein when a failure occurs in said electric/heat energy module or heat energy generating module, information of the failure in the module is displayed on the module unit basis.

10. The cogeneration system according to claim 1, comprising a plurality of said electric/heat energy modules and a plurality of said heat energy generating modules.

11. An energy supply system comprising:
a plurality of heat energy generating modules each having a heat energy generating source for generating heat energy; and
a base having therein said plurality of heat energy generating sources,
wherein said heat energy generating source has an energy transmitter for transmitting generated heat to the outside of the module, and
said base has therein a heat energy input part to which the heat energy transmitted from the energy transmitter of said heat energy generating module is sent.
